(19) United States
(12) Patent Application Publication
(10) Pub. No.: US 2026/0177529 A1
(43) Pub. Date: Jun. 25, 2026

(54) 3D PRINTED SCAFFOLDS FOR THE ENHANCEMENT OF POLYMER COATING TECHNIQUES FOR TUNABLE MEMS SENSORS

(71) Applicant: Georgia Tech Research Corporation, Atlanta, GA (US)

(72) Inventors: Biya D. Haile, Atlanta, GA (US); Luke A. Beardslee, Atlanta, GA (US); Oliver Brand, Atlanta, GA (US)

(21) Appl. No.: 19/426,814

(22) Filed: Dec. 19, 2025

Related U.S. Application Data
(60) Provisional application No. 63/735,931, filed on Dec. 19, 2024.

(51) Int. Cl. G01N 29/22; C09D 175/04; C09D 183/06; G01N 29/036

(52) U.S. Cl. CPC G01N 29/222; C09D 175/04; C09D 183/06; G01N 29/036

(57) ABSTRACT

The present disclosure relates generally to chemical sensors and polymer coatings for chemical sensors, and more particularly to a sensing system including a sensor having a polymeric 3D printed coating disposed on a surface thereof. A sensing system includes a sensor including a resonator structure. The sensing system includes a polymeric 3D printed coating disposed on a surface of at least a portion of the sensor. The polymeric 3D printed coating includes a three-dimensional scaffold structure.

### CROSS-REFERENCE TO RELATED APPLICATIONS

This application claims the benefit of U.S. Provisional Application Ser. No. 63/735,931, filed on 19 Dec. 2024, which is incorporated herein by reference in its entirety as if fully set forth below

### FIELD OF INVENTION

The present disclosure relates to chemical sensors and polymer coatings for chemical sensors, and more particularly to a sensing system comprising a sensor having a polymeric 3D printed coating disposed on a surface thereof, and a method of sensing using such a system.

### BACKGROUND

The field of chemical sensing has developed various technologies for detecting volatile organic compounds (VOCs) in ambient conditions. Current systems include gas chromatography-mass spectrometry (GC-MS) instruments, metal oxide sensors, carbon-based sensors, electrochemical sensors, and resonant chemical microsensors. Among these, resonant chemical microsensors utilize gravimetric transduction principles where analyte absorption by a sensing film causes a measurable change in the resonant frequency of a vibrating structure. These devices typically employ cantilever-based or hammerhead resonator designs that incorporate electrothermal excitation and piezoresistive detection mechanisms. The sensing capability of such resonant microsensors depends substantially on the polymer sensing films applied to their surfaces, which absorb target analytes and thereby increase the effective mass of the resonator.

Present methods for applying polymer sensing films to chemical sensors include spray coating, inkjet printing, spin coating, drop casting, and micro-plotting techniques. These ex-situ coating approaches involve depositing pre-synthesized polymer materials onto transducer surfaces through various physical deposition mechanisms. Spray coating utilizes an atomizer to precipitate polymer-based sorbents dissolved in a solvent through a mask to create thin polymer layers. Inkjet printing deposits polymer solutions through micro-nozzles using piezoelectric actuation. Spin coating applies polymer mixtures to achieve relatively uniform layers on sensor surfaces. Each of these techniques has been employed to functionalize resonant chemical sensors for VOC detection applications.

However, existing polymer coating methods suffer from several limitations that affect sensor performance and manufacturing consistency. Spray coating techniques produce films with variable thickness because nucleated polymer particles can pass under masking elements, resulting in non-uniform coverage. Inkjet printing often produces films exhibiting the “coffee ring” effect, where polymer layers are significantly thicker at the edges and thinner at the center, particularly when coating beyond a few microns in thickness. Spin coating may require additives such as poly(methyl methacrylate) that lack sensitivity to VOC gases and impede analyte adsorption, while also presenting difficulties in controlling layer homogeneity and producing thin films. Drop casting methods present challenges in controlling uniformity and thickness of deposited layers. Additionally, these conventional coating techniques cannot readily deposit films with high surface-area-to-volume ratios, which would be desirable for optimizing analyte absorption onto sensor surfaces. A thick polymer sensing layer can increase sensor sensitivity, but it also increases response time because analytes must diffuse through the relatively thick sensing film. Furthermore, these methods face challenges related to solvent compatibility, viscosity control, and evaporation time, which limit control over film shape, thickness, and manufacturing throughput.

What is needed, therefore, is an improved approach for applying polymer sensing films to chemical sensors that provides enhanced control over film geometry, thickness uniformity, and surface-area-to-volume ratio. Such an approach would enable the fabrication of sensing films with high porosity structures that allow analyte diffusion from multiple directions, thereby achieving both high sensitivity and reduced response time while improving manufacturing repeatability and throughput.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a sensing system is provided. The sensing system can include a sensor including a resonator structure. The sensing system can include a polymeric 3D printed coating disposed on a surface of at least a portion of the sensor. The polymeric 3D printed coating can include a three-dimensional scaffold structure.

According to another aspect of the present disclosure, a chemical sensor device is provided. The chemical sensor device can include a cantilever-based resonator having a head region and a cantilever portion. The chemical sensor device can include a polymer sensing film disposed on at least a portion of the head region. The polymer sensing film can include a 3D printed structure formed by two-photon polymerization.

According to another aspect of the present disclosure, a method of detecting an analyte is provided. The method can include providing a sensing system including a sensor having a polymeric 3D printed coating disposed on a surface thereof. The method can include exposing the sensing system to an environment containing one or more analytes. The method can include measuring a frequency change of the sensor in response to absorption of the one or more analytes by the polymeric 3D printed coating.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF FIGURES

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates a conventional cantilever-based resonant chemical microsensor.

FIG. 2 illustrates a gyroid lattice structure, according to examples of the disclosed technology.

FIG. 3 illustrates a resonant chemical microsensor with a 3D printed polymer scaffold, according to examples of the disclosed technology.

FIG. 4 illustrates a two-photon polymerization 3D printing process, according to examples of the disclosed technology.

FIG. 5A illustrates microscope and scanning electron microscope images of a resonant chemical microsensor with a spray-coated polymer coating.

FIG. 5B illustrates microscope and scanning electron microscope images of a resonant chemical microsensor with a 3D printed polymer block coating.

FIG. 5C illustrates microscope and scanning electron microscope images of a resonant chemical microsensor with a 3D printed polymer scaffold structure, according to examples of the disclosed technology.

FIG. 6A illustrates a scanning electron microscope image of a resonant chemical microsensor with a 3D printed polymer scaffold, according to examples of the disclosed technology.

FIG. 6B illustrates a scanning electron microscope image of a resonant chemical microsensor with a 3D printed polymer scaffold, according to examples of the disclosed technology.

FIG. 7 illustrates a graph showing frequency change over time for sensors exposed to an analyte, according to examples of the disclosed technology.

FIG. 8A illustrates a graph showing measured relative frequency change as a function of analyte concentration for ethylbenzene, according to examples of the disclosed technology.

FIG. 8B illustrates a graph showing measured relative frequency change as a function of analyte concentration for M-xylene, according to examples of the disclosed technology.

FIG. 8C illustrates a graph showing measured relative frequency change as a function of analyte concentration for toluene, according to examples of the disclosed technology.

FIG. 9A illustrates a graph showing measured relative frequency change as a function of analyte concentration for ethylbenzene for different sensor configurations, according to examples of the disclosed technology.

FIG. 9B illustrates a graph showing measured relative frequency change as a function of analyte concentration for M-xylene for different sensing film geometries, according to examples of the disclosed technology.

FIG. 9C illustrates a graph showing measured relative frequency change as a function of analyte concentration for toluene for different sensing film geometries, according to examples of the disclosed technology.

FIG. 10A illustrates a graph showing measured relative frequency change as a function of analyte concentration for M-xylene for different sensing film configurations, according to examples of the disclosed technology.

FIG. 10B illustrates a graph showing measured relative frequency change as a function of analyte concentration for toluene for different sensing film configurations, according to examples of the disclosed technology.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

The present disclosure relates to a sensing system configured for detecting one or more analytes. In some cases, the sensing system can comprise a sensor having a polymeric 3D printed coating disposed on a surface of at least a portion of the sensor. The polymeric 3D printed coating can comprise a three-dimensional scaffold structure configured to absorb analytes from a surrounding environment. The three-dimensional scaffold structure can provide a high surface-area-to-volume ratio, which can enhance sensitivity and reduce response time compared to conventional polymer coatings applied through spray coating, inkjet printing, or other deposition techniques.

In some cases, the sensing system can be configured to detect volatile organic compounds (VOCs). VOCs can include compounds such as ethylbenzene, M-xylene, toluene, and other aromatic hydrocarbons that are commonly used as solvents across various industries. Detection of VOCs can be relevant for air quality monitoring, healthcare diagnostics, and other applications where accurate identification and quantification of gaseous compounds is desired.

The polymeric 3D printed coating can be formed using two-photon polymerization (TPP), which can enable fabrication of three-dimensional nanostructures with sub-micrometer resolution. Two-photon polymerization can confine light absorption to a focal volume of a laser beam due to optical nonlinearity, thereby enabling selective crosslinking of a photoresin at arbitrary locations within a three-dimensional space. The selective crosslinking can allow for creation of complex scaffold geometries that are not achievable through conventional coating methods such as drop-casting, spin-coating, or spray-coating. Additionally, because the printed polymer can be crosslinked, it does not present the same issue with flying off the head of the resonator suffered by many conventional spray-coated polymer films.

The three-dimensional scaffold structure can comprise a triply periodic minimal surface (TPMS) geometry. A triply periodic minimal surface can be an infinitely connected surface that repeats periodically in three spatial dimensions. In some cases, the triply periodic minimal surface geometry can comprise a gyroid lattice. A gyroid lattice can provide structural stability, nearly isotropic characteristics, and a favorable strength-to-lattice density ratio. The gyroid lattice can also provide a high surface area to volume ratio, which can facilitate rapid diffusion of analytes into the polymeric 3D printed coating from multiple directions.

It should be noted that while some embodiments are described herein and shown in the figures as including a gyroid geometry, the disclosure should be read as so limited. Rather, as those skilled in the art would understand, a diverse variety of three-dimensional structures are contemplated within the scope of the present disclosure. Such structures can be tailored to physical and chemical properties of particular analyte. Accordingly, the present disclosure enables the creation of many TPMS structures, beyond gyroid, by manipulating certain parameters, such as infill density and cell size, to produce an optimal film that improves selectivity while maintaining reaction time.

The polymeric 3D printed coating can comprise various photoresin compositions. In some cases, the polymeric 3D printed coating can comprise an elastomeric photoresin. The elastomeric photoresin can comprise (acryloxypropyl)methylsiloxane-dimethylsiloxane copolymer, N, N Dioctyl-1-octanamine or trioctylamine, and (3-acryloxy-2-hydroxypropoxypropyl) terminated polydimethylsiloxane (PDMS). In some cases, the polymeric 3D printed coating can comprise a polyurethane-based resin. The polyurethane-based resin can be synthesized by combining urethane acrylate methacrylate resin with a photoinitiator such as 2-Benzyl-2-(dimethylamino)-4′-morpholinobutyrophenone. The photoresin compositions can be solvent-free and can exhibit shelf stability for extended periods.

The sensing system can operate based on gravimetric sensing principles. When analytes are absorbed by the polymeric 3D printed coating, a mass of the sensor can increase, which can cause a change in a resonant frequency of the sensor. The change in resonant frequency can be measured and correlated to a concentration of the analytes in the surrounding environment. The three-dimensional scaffold structure can enhance sensitivity by increasing the amount of analyte that can be absorbed per unit volume of the polymeric 3D printed coating while maintaining a low response time due to the multiple diffusion pathways provided by the scaffold geometry.

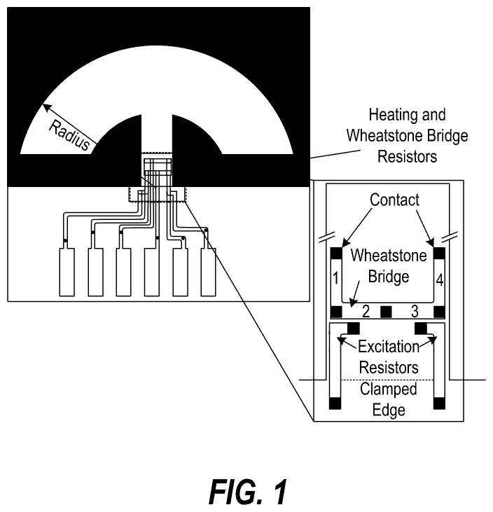

Referring to FIG. 1, a conventional cantilever-based resonant chemical microsensor is shown without a sensing film disposed thereon. The resonant chemical microsensor can comprise a sensor having a resonator structure. The resonator structure can comprise a semicircular annulus and a cantilever. In some cases, the semicircular annulus can have an inner radius and an outer radius that define an annular region. The cantilever can extend from the semicircular annulus to a substrate portion of the device.

With continued reference to FIG. 1, the cantilever-based resonator can have a head region and a cantilever portion. The head region can comprise the semicircular annulus. The cantilever-based resonator can comprise a hammerhead configuration in which the semicircular annulus is supported by the cantilever portion. The hammerhead configuration can feature a wide head region that is supported by a narrower cantilever portion, which can allow the head region to be coated with a sensing film while isolating the sensing film from the cantilever portion where deflection occurs.

As further shown in FIG. 1, the resonant chemical microsensor can include a plurality of contact pads arranged along a bottom edge of the device. The contact pads can provide electrical connections for operating the sensor. The cantilever portion can include a region containing heating resistors and Wheatstone bridge resistors, as indicated by a dashed box in the main image of FIG. 1.

An enlarged inset in FIG. 1 provides a detailed view of a resistor configuration disposed on the cantilever portion. The sensor can incorporate electrothermal excitation and piezoresistive detection of in-plane flexural mode. The resistor configuration can include at least one excitation resistor configured to provide electrothermal excitation of the resonator structure. The piezoresistive sensing resistors can be configured in a Wheatstone bridge arrangement. The Wheatstone bridge can comprise four resistor positions that enable detection of deflection of the cantilever portion. A contact can be disposed at a top portion of the resistor configuration, and a clamped edge can be disposed at a bottom portion where the cantilever portion connects to the substrate.

The hammerhead design configuration can separate the head region from the cantilever portion, which can reduce viscoelastic dampening effects when a polymeric sensing film is applied to the head region. The in-plane flexural mode can cause the resonator structure to vibrate back and forth in a plane parallel to a surface of the substrate rather than perpendicular to the surface. The chemical sensor device can operate by measuring a resonant frequency of the resonator structure, which can change when analytes are absorbed by a sensing film disposed on the head region.

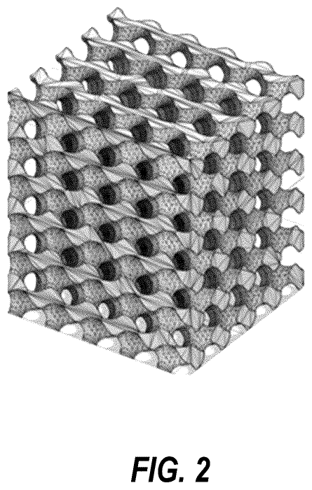

Referring to FIG. 2, a gyroid lattice structure is shown. The gyroid lattice structure can be an infinitely connected triply periodic minimal surface (TPMS) utilized in the creation of scaffolds during a 3D printing process. A triply periodic minimal surface can be a surface that repeats periodically in three spatial dimensions and has zero mean curvature at each point. The gyroid lattice structure can exhibit a repeating pattern of interconnected curved surfaces that form a network of channels and voids throughout a volume.

With continued reference to FIG. 2, the gyroid geometry can feature smooth, continuous surfaces that curve and intersect in a regular, periodic manner across three spatial dimensions. The three-dimensional scaffold structure can comprise the triply periodic minimal surface geometry, and the triply periodic minimal surface geometry can comprise the gyroid lattice. The gyroid lattice can provide structural stability while maintaining nearly isotropic characteristics, meaning mechanical properties can be substantially uniform in all directions.

As further shown in FIG. 2, the gyroid pattern can represent a unit cell that can be repeated to fill a desired volume. The curved surfaces can create open pathways that allow for fluid or gas flow through the structure. The gyroid lattice structure can demonstrate a high surface area to volume ratio due to the extensive network of internal surfaces created by the interconnected channels. The high surface area to volume ratio can facilitate rapid diffusion of analytes into a polymeric 3D printed coating from multiple directions, which can enhance sensitivity while maintaining a low response time.

The gyroid structure can have a 50% infill density. The 50% infill density can provide a balance between structural integrity and open volume for analyte diffusion. The gyroid structure can have a Feret diameter of approximately 10-11 μm. The Feret diameter can represent a longest distance between any two points along a selection boundary of features within the gyroid pattern.

In some cases, a sensing system can comprise a sensor having a polymeric 3D printed coating disposed on a surface thereof, wherein the polymeric 3D printed coating comprises a three-dimensional scaffold structure. The three-dimensional scaffold structure can comprise the triply periodic minimal surface geometry. In some cases, a chemical sensor device can comprise a polymer sensing film disposed on at least a portion of a head region, wherein the polymer sensing film comprises a 3D printed structure formed by two-photon polymerization. The 3D printed structure can comprise the triply periodic minimal surface geometry, and the triply periodic minimal surface geometry can comprise the gyroid lattice.

The gyroid lattice can be selected for its favorable strength-to-lattice density ratio. The gyroid geometry can maximize surface area exposure while minimizing material usage, making the gyroid lattice suitable for applications where interaction between the structure and surrounding media is desired. The nearly isotropic characteristics of the gyroid lattice can provide consistent mechanical behavior regardless of the direction of applied forces or analyte diffusion.

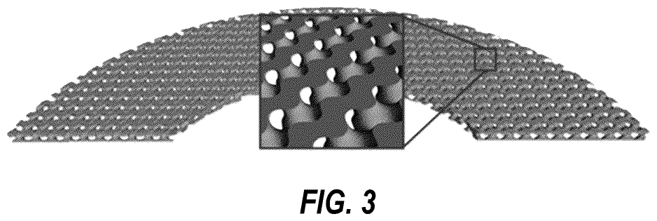

Referring to FIG. 3, a resonant chemical microsensor with a 3D printed polymer scaffold disposed on a sensing region is shown. The resonant chemical microsensor can comprise a sensor having a polymeric 3D printed coating disposed on a surface of at least a portion of the sensor. The polymeric 3D printed coating can comprise a three-dimensional scaffold structure. The three-dimensional scaffold structure can exhibit a gyroid lattice configuration that provides a high surface area to volume ratio for enhanced analyte absorption.

With continued reference to FIG. 3, the resonant chemical microsensor can feature a hammerhead configuration comprising a semicircular annulus supported by a cantilever beam. The resonator structure can comprise a 20-μm thick semicircular annulus with an inner radius of 100-μm and an outer radius of 200-μm. The cantilever can measure 100-μm in length and 45-μm in width. The semicircular annulus can include two wing-like portions extending outward from a central region where the cantilever attaches.

As further shown in FIG. 3, the polymeric 3D printed coating can be disposed on at least a portion of an outer surface of the semicircular annulus. In some cases, the polymeric 3D printed coating can be disposed on at least a portion of a top surface of the semicircular annulus. The surface of the semicircular annulus can be covered with the polymeric 3D printed coating that exhibits the gyroid lattice structure. The 3D printed structure can have a height of 5-μm.

The chemical sensor device can comprise a cantilever-based resonator having a head region and a cantilever portion. A polymer sensing film can be disposed on at least a portion of the head region. The polymer sensing film can comprise a 3D printed structure formed by two-photon polymerization. The gyroid structure can be characterized by a repeating pattern of interconnected curved surfaces forming a triply periodic minimal surface geometry.

An inset magnification in FIG. 3 can show a detailed structure of the gyroid lattice, revealing the high surface area to volume ratio achieved through an interconnected porous network. The gyroid pattern can consist of regularly spaced openings or voids distributed throughout the polymer scaffold, creating channels that allow analyte gases to diffuse into the sensing material from multiple directions.

The 3D printed polymer scaffold can be confined to the head region of the resonator and does not extend onto the cantilever portion. The confinement of the polymeric 3D printed coating away from the cantilever portion can help maintain mechanical properties of the device while maximizing the sensing surface area. The resonator can vibrate in-plane in a flexural mode rather than out-of-plane, which can reduce viscoelastic dampening effects of the polymeric sensing film when the sensing film is isolated from the cantilever portion where deflection occurs. This configuration can enable enhanced sensitivity and improved response time for volatile organic compound detection compared to conventional spray-coated polymer films.

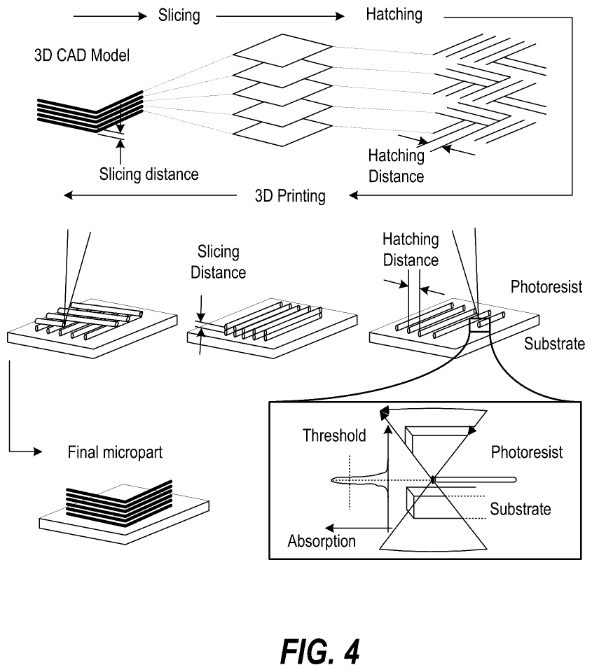

Referring to FIG. 4, a schematic diagram of a two-photon polymerization 3D printing process is shown. The upper portion of FIG. 4 illustrates a workflow from a 3D CAD model through slicing and hatching operations to 3D printing. A 3D CAD model can be shown as a layered rectangular structure, which can then be processed through slicing to create horizontal layers separated by a slicing distance. The sliced model can undergo hatching, where diagonal lines can be applied across each layer with a defined hatching distance between adjacent lines.

With continued reference to FIG. 4, the lower portion of the figure shows a physical 3D printing process. A focused laser beam can be directed onto a substrate coated with photoresist material. The slicing distance can correspond to vertical spacing between printed layers, while the hatching distance can correspond to horizontal spacing between printed features within each layer. The 3D printing can be performed using a femtosecond laser directed through a Zeiss 25×objective lens with a numerical aperture (NA) of 0.8.

As further shown in FIG. 4, a detailed inset diagram shows an interaction between the laser beam and the photoresist at a focal point, illustrating a threshold region where two-photon absorption occurs within the photoresist above the substrate. An absorption profile can be depicted as an hourglass-shaped region where laser energy is concentrated, enabling selective polymerization of the photoresist material. Due to optical nonlinearity, light absorption can be confined to a focal volume of the laser beam, enabling arbitrary 3D printing at precise locations within the photoresist.

The 3D printing can use a dip-in laser lithography (DiLL) setup where the objective lens is dipped directly into the resin. In the DiLL configuration, the femtosecond laser can be concentrated through the objective lens and scanned by a computer-controlled galvanometer within the resin. The 3D printing fabrication can be conducted within the 25×field of view to print the structures for improved accuracy and print quality.

In some cases, optimal printing parameters can comprise a core laser power of 80%/40 mW at a core scan speed of 100,000 μm/s. The printing parameters can be optimized by running multiple parameter sweeps to find an optimal setting for printing on the sensor. A final micropart resulting from the printing process can be shown as a layered structure with characteristic geometry defined by the slicing and hatching parameters. The two-photon polymerization process can enable fabrication of three-dimensional nanostructures with sub-micrometer resolution, which can allow for creation of complex scaffold geometries such as the gyroid lattice structure.

The polymeric 3D printed coating can comprise various photoresin compositions suitable for two-photon polymerization. In some cases, the polymeric 3D printed coating can comprise an elastomeric photoresin. The elastomeric photoresin can comprise at least 90 wt. % of (acryloxypropyl)methylsiloxane-dimethylsiloxane copolymer. In some cases, the elastomeric photoresin can comprise at least 5 wt. % of N,N Dioctyl- 1-octanamine or trioctylamine. In some cases, the elastomeric photoresin can comprise no more than 5 wt. % of (3-acryloxy-2-hydroxypropoxypropyl) terminated polydimethylsiloxane (PDMS). The elastomeric photoresin can be a proprietary photosensitive acrylate elastomeric polymer that is hydrophobic and non-cytotoxic.

In some cases, the polymeric 3D printed coating can comprise a polyurethane-based resin. The polyurethane-based resin can be a custom-synthesized resin made by mixing urethane acrylate methacrylate resin with a photoinitiator. In some cases, the polyurethane-based resin can be made by mixing 98 wt % of urethane acrylate methacrylate resin with 2 wt % of 2-Benzyl-2-(dimethylamino)-4′-morpholinobutyrophenone as the photoinitiator. The 2-Benzyl-2-(dimethylamino)-4′-morpholinobutyrophenone can be a type-2 photoinitiator that operates within a near ultraviolet and visible spectrum. The photoinitiator can be integrated into a polymeric matrix, which can generate radicals through radical chain polymerization upon UV irradiation.

The custom resin synthesis can be accomplished by magnetically stirring the mixture at 1000 rpm speed for 24 hours at a temperature of 60° C. to attain a homogeneous resin. A final weight percentage of each polymer in the resin can be determined by conducting a parameter sweep while varying a composition ratio. The photoinitiator content in the resin can be minimized to less than 5 w t% to maintain gas sensitivity of the polymer. The sensitivity loss attributed to added impurities in the resin can be offset by an increased surface area to volume ratio provided by the three-dimensional scaffold structure.

The urethane acrylate methacrylate resin (UDMA) can be formed by reacting 2,4,4-trimethylhexamethylene diisocyanate and 2-hydroxyethyl methacrylate (HEMA). The UDMA can serve as a base polymer that provides structural integrity and gas absorption properties for the sensing film.

In some cases, a sensing system can comprise a sensor having a polymeric 3D printed coating disposed on a surface thereof, wherein the polymeric 3D printed coating comprises the elastomeric photoresin or the polyurethane-based resin. In some cases, a chemical sensor device can comprise a polymer sensing film disposed on at least a portion of a head region, wherein the polymer sensing film comprises a solvent-free photoresin. Both the elastomeric photoresin and the polyurethane-based resin can be solvent-free and can exhibit shelf stability for multiple uses throughout extended periods, lasting up to one year. The solvent-free nature of the photoresins can facilitate the two-photon polymerization process and can reduce complications associated with solvent evaporation during printing.

Following the printing process, samples can undergo a post-processing procedure to remove unreacted resin from the printed structures. The post-processing procedure can comprise immersion of the samples in propylene glycol monomethyl ether acetate (PGMEA) for a duration of 30 minutes to ensure complete dissolution of unreacted resin. The immersion in PGMEA can be followed by a rinse in isopropyl alcohol (IPA) for 10 minutes to eliminate any residual PGMEA from the printed structures. The post-processing procedure can help ensure that the three-dimensional scaffold structure is free of uncured photoresin material that could otherwise affect sensing performance.

A custom-made aluminum chip holder can be used to mount a sensor die for 3D printing alignment. The chip holder can facilitate positioning of the sensor die within a 3D printing system during the two-photon polymerization process. Alignment can be performed on the custom chip holder using manual alignment procedures along with manual laser control to ensure proper interface positioning. To verify alignment of a design on the resonator, a custom mask can be created and projected onto a screen, with fine angular adjustments carried out tular adjustments carried out through a printing system interface. The custom chip holder can enable precise placement of the polymeric 3D printed coating on designated regions of the sensor while avoiding deposition on regions where the coating is not desired, such as the cantilever portion.

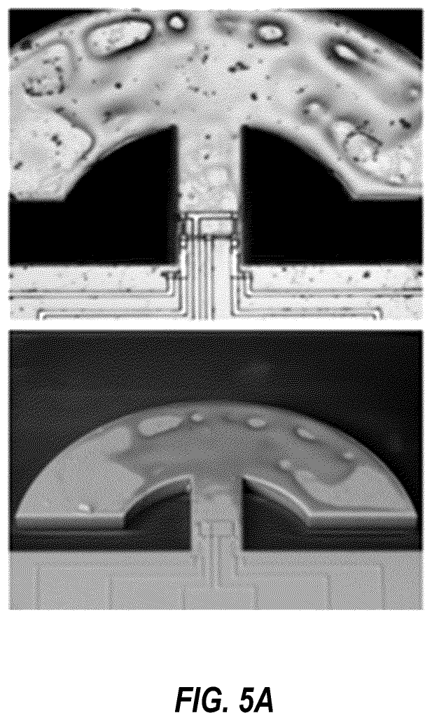

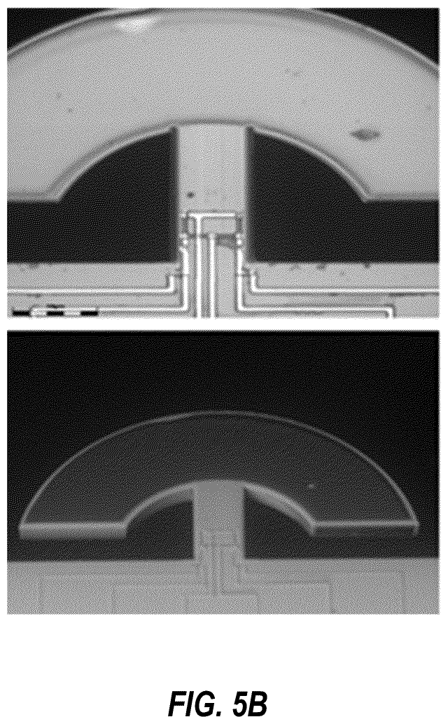

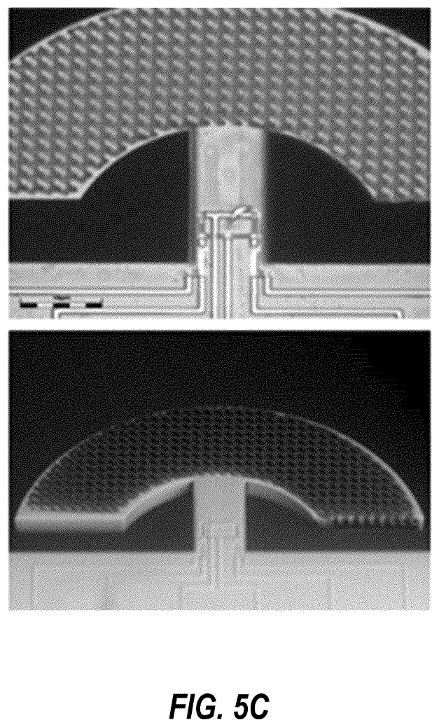

Referring to FIG. 5A, microscope and scanning electron microscope (SEM) images comparing different polymer coating methods on the resonant microsensor are shown. The upper image in FIG. 5A can be obtained from an optical microscope illustrating a polymer's surface quality and color, while the lower image can be acquired from a scanning electron microscope depicting alignment quality on the resonator. The upper image shows a semicircular annulus structure of the hammerhead resonator with a polymer coating applied to a surface thereof. The coating can exhibit a textured appearance with visible surface features and variations in thickness across the annular region. The cantilever portion extending downward from the annulus can be visible, along with a supporting substrate structure below.

With continued reference to FIG. 5A, the lower image presents an SEM view of a similar resonator structure, showing the semicircular annulus with a smoother, more uniform appearance characteristic of a spray-coated polymer coating. The SEM image can reveal finer structural details of the resonator geometry, including precise edges of the annulus and a cantilever connection point. A substrate beneath the suspended resonator structure can be visible, demonstrating a depth of an etched cavity that allows the resonator to vibrate freely. The spray-coated polymer coating can be applied using an atomizer to precipitate polymer-based sorbents dissolved in an appropriate solvent through a mask to create a thin VOC sensitive polymer layer on the transducer. The spray-coating method can complicate regulation of film thickness, as nucleated polymer particles can pass under the mask during deposition.

Referring to FIG. 5B, microscope and scanning electron microscope (SEM) images showing two views of a resonant chemical microsensor with a 3D printed polymer coating disposed on the semicircular annulus region are shown. The upper microscope image in FIG. 5B shows a top-down view of the hammerhead resonator structure, displaying the semicircular annulus connected to a cantilever beam. The polymer coating can be visible on the annulus portion, positioned away from the cantilever where deflection occurs. The cantilever can include visible electrical traces and connection points for piezoresistive sensing resistors and excitation resistors.

With continued reference to FIG. 5B, the lower SEM image shows a similar view of the resonator from a different angle or of a different device, illustrating the semicircular head region with a polymer sensing film applied to an outer surface. Dark regions surrounding the resonator structure can indicate an etched cavity beneath the suspended device. In some cases, the 3D printed structure can comprise a solid block geometry without TPMS scaffold features. The solid block geometry can provide a uniform polymer layer on the sensing region but can have a lower surface area to volume ratio compared to scaffold structures with gyroid geometry.

Referring to FIG. 5C, microscope and scanning electron microscope (SEM) images showing a resonant chemical microsensor with a 3D printed polymer scaffold structure are shown. The upper microscope image in FIG. 5C provides a top-down view of the hammerhead resonator structure, displaying semicircular annulus regions on either side of a central cantilever support. The annulus surfaces can feature a dense gyroid lattice pattern created through two-photon polymerization, demonstrating a high surface area to volume ratio scaffold geometry. A central region can show the cantilever beam with associated electrical traces and connection points for piezoresistive sensing and electrothermal excitation elements.

As further shown in FIG. 5C, the lower SEM image presents an angled perspective view of a similar resonator structure, showing a three-dimensional nature of the printed gyroid scaffold on the semicircular head region. The view can reveal a curved profile of the annulus and can demonstrate how the 3D printed polymer coating is confined to the head region while avoiding the cantilever beam where deflection occurs. The gyroid pattern visible on the surface can consist of interconnected periodic minimal surface structures that maximize available surface area for analyte absorption while maintaining structural integrity.

The comparison between FIGS. 5A, 5B, and 5C demonstrates differences in surface morphology and coating uniformity achievable through various polymer deposition techniques on the MEMS resonant chemical sensor platform. The spray-coated polymer coating shown in FIG. 5A can exhibit non-uniform thickness and surface texture due to limitations of the spray-coating process. The 3D printed solid block coating shown in FIG. 5B can provide more controlled thickness and placement compared to spray-coating but can have limited surface area for analyte interaction. The 3D printed gyroid scaffold structure shown in FIG. 5C can provide both controlled placement and a high surface area to volume ratio through the interconnected porous network of the triply periodic minimal surface geometry. The gyroid scaffold structure can enable enhanced sensitivity and improved response time for volatile organic compound detection by allowing analyte gases to diffuse into the sensing material from multiple directions simultaneously.

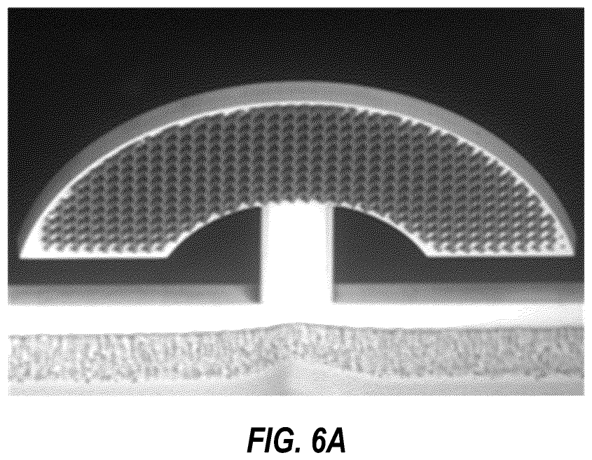

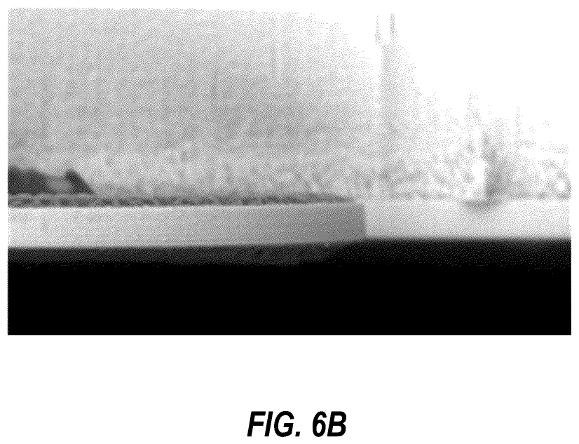

Referring to FIG. 6A, a scanning electron microscope (SEM) image of a resonant chemical microsensor with a 3D printed polymer scaffold disposed on a surface of the semicircular annulus region is shown. The SEM image shows the hammerhead-shaped sensor structure comprising the semicircular annulus supported by a central cantilever extending downward. The semicircular annulus can feature a 3D printed polymer coating with a gyroid lattice structure, which can provide a high surface-area-to-volume ratio for enhanced analyte absorption. The gyroid pattern can be visible as a repeating network of interconnected pores distributed across an upper surface of the annulus on both sides of the central cantilever support.

With continued reference to FIG. 6A, the cantilever portion connecting the annulus to the substrate can remain free of the polymer coating, which can help alleviate viscoelastic dampening effects and maintain high-Q operation of the resonator. Below the suspended sensor structure, a portion of an underlying substrate can be visible, showing an etched cavity that allows the hammerhead structure to vibrate freely in the in-plane flexural mode. The cross-sectional perspective can demonstrate how the 3D printed scaffold is confined to the head region of the sensor while avoiding high-strain areas near a beam support.

Referring to FIG. 6B, a scanning electron microscope (SEM) image of a resonant chemical microsensor with a 3D printed polymer scaffold disposed on a surface thereof is shown. The SEM image shows a side profile of the sensor structure, revealing a layered construction of the device. A lower portion of the image can show a dark region representing the substrate or base material. Above the substrate, a lighter colored layer can be visible, which can correspond to the silicon-based resonator structure. On top of the resonator, a textured polymer coating can be observed, displaying a characteristic porous structure of the 3D printed sensing film.

As further shown in FIG. 6B, the polymer layer can exhibit a rough, granular surface texture indicative of the high surface area scaffold geometry achieved through two-photon polymerization. The side view can demonstrate a thickness and uniformity of the polymer coating relative to the underlying sensor structure. A distinct boundary can be visible between different regions of the device, showing an interface between coated and uncoated portions of the sensor surface. The side profile view can provide insight into a vertical arrangement of the sensing film on the resonator, illustrating how the 3D printed polymer scaffold is positioned on the sensor head region while maintaining separation from other structural elements of the device.

In some cases, the polymeric 3D printed coating can be disposed on at least a portion of a bottom surface of the semicircular annulus. The two-photon polymerization process can enable printing on a backside of the device, which is a capability not achievable through conventional spray coating methods. To print on the backside, the resonator can be inverted and mounted to a chip holder to facilitate printing on a reverse side of the device. The ability to print on both top and bottom surfaces of the head region can amplify sensitivity while minimizing polymer volume, which can enhance a limit of detection.

In some cases, a sensing system can comprise a sensor having a polymeric 3D printed coating disposed on a surface thereof, wherein the polymeric 3D printed coating is disposed on at least a portion of a top surface of the semicircular annulus and on at least a portion of a bottom surface of the semicircular annulus. In some cases, a chemical sensor device can comprise a polymer sensing film disposed on both a top surface and a bottom surface of the head region. The double-sided printing configuration can enhance stability by increasing a quality factor, as polymer mass distribution can be uniform on both sides of the resonator and confined to unstrained areas of the resonator.

In some cases, the polymeric 3D printed coating can be disposed on an edge or sidewalls of the resonator head region. The two-photon polymerization process can enable deposition of the polymer scaffold along sidewall surfaces of the semicircular annulus in addition to top and bottom surfaces. The ability to coat sidewall surfaces can further increase a total surface area available for analyte absorption, which can enhance sensitivity of the sensing system.

A method of detecting an analyte can comprise providing a sensing system comprising a sensor having a polymeric 3D printed coating disposed on a surface thereof. The method can further comprise exposing the sensing system to an environment containing one or more analytes. The method can further comprise measuring a frequency change of the sensor in response to absorption of the one or more analytes by the polymeric 3D printed coating. In some cases, the one or more analytes can comprise volatile organic compounds. The volatile organic compounds can include compounds such as ethylbenzene, M-xylene, toluene, and other aromatic hydrocarbons.

The sensing system can include a closed-loop embedded system utilizing an amplifying feedback loop to operate the resonator. The amplifying feedback loop can maintain oscillation of the resonator at a resonant frequency by providing positive feedback to compensate for energy losses during vibration. The closed-loop configuration can enable continuous monitoring of the resonant frequency without requiring external frequency sweep measurements.

The sensing system can operate with a higher dilution rate at a total flow rate of 210 mL/min for low VOC concentration detection. The higher dilution rate can reduce the partial pressure of the volatile organic compound analyte in the carrier gas stream, enabling detection and characterization of sensor response at lower analyte concentrations. The higher total flow rate can be achieved by increasing flow through the secondary nitrogen dilution line while maintaining flow through the bubbler line. The ability to operate at different dilution rates can enable characterization of sensor performance across a wide range of analyte concentrations, from high concentrations in the thousands of parts per million range to low concentrations in the tens of parts per million range.

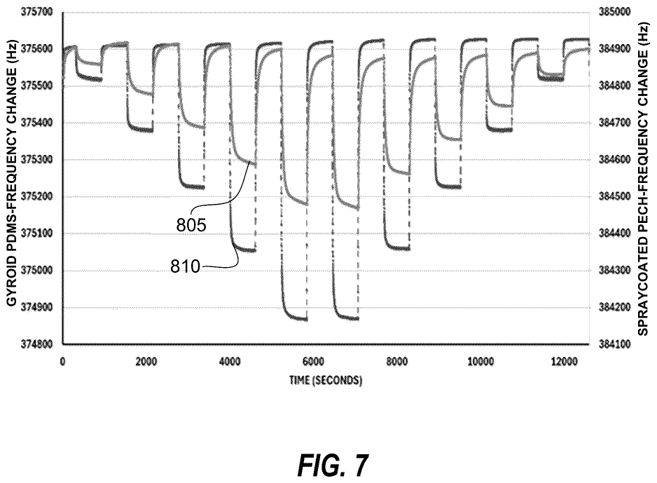

Referring to FIG. 7, a graph showing simultaneously measured frequency over time for two sensors when exposed to different concentrations of an analyte is shown. The graph can include two y-axes, with a left y-axis labeled “GYROID PDMS-FREQUENCY CHANGE (Hz)” ranging from approximately 374800 to 375700 Hz, and a right y-axis labeled “SPRAYCOATED PECH-FREQUENCY CHANGE (Hz)” ranging from approximately 384100 to 385000 Hz. An x-axis can be labeled “TIME (SECONDS)” and can span from 0 to 12000 seconds.

With continued reference to FIG. 7, a first curve 805 can represent frequency measurements from a gyroid PDMS 3D-printed sensor. The first curve 805 can be shown as a solid line that exhibits a series of downward frequency shifts followed by recovery periods. The downward frequency shifts can correspond to periods when the sensor is exposed to the analyte, during which analyte molecules can be absorbed by the polymeric 3D printed coating and can increase a mass of the sensor, thereby decreasing the resonant frequency. The recovery periods can correspond to purge steps during which the carrier gas can flow over the sensor without analyte present, allowing absorbed analyte molecules to desorb from the polymeric 3D printed coating and the resonant frequency to return toward a baseline value.

As further shown in FIG. 7, a second curve 810 can represent frequency measurements from a spray-coated PECH sensor. The second curve 810 can be shown as a dashed line that displays similar downward frequency shifts and recovery periods occurring simultaneously with the first curve 805. The simultaneous occurrence of frequency shifts in the first curve 805 and the second curve 810 can result from both sensors being exposed to the same analyte concentrations at the same times during the measurement.

The first curve 805 can demonstrate larger magnitude frequency changes compared to the second curve 810 across the measurement period. The larger magnitude frequency changes exhibited by the gyroid PDMS 3D-printed sensor can be attributed to the high surface area to volume ratio provided by the gyroid lattice structure of the polymeric 3D printed coating. The gyroid lattice structure can allow analyte molecules to diffuse into the sensing material from multiple directions simultaneously, which can increase the amount of analyte absorbed per unit time and per unit volume of the sensing film compared to the spray-coated polymer film.

Both the first curve 805 and the second curve 810 can demonstrate repeated cycles of frequency decrease during analyte exposure followed by frequency recovery during purge steps. The repeated cycles can correspond to sequential exposures to increasing and decreasing analyte concentrations during the measurement. The gyroid PDMS sensor represented by the first curve 805 can show approximately 2.5 times higher frequency change upon analyte adsorption compared to the spray-coated PECH sensor represented by the second curve 810. The enhanced frequency response of the gyroid structure can enable improved sensitivity and lower limits of detection for volatile organic compound sensing applications.

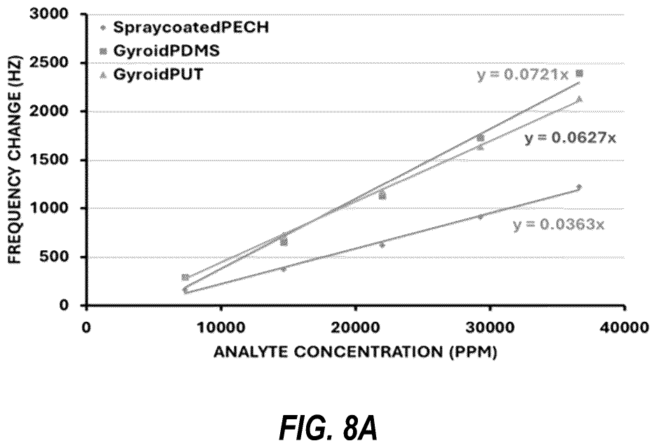

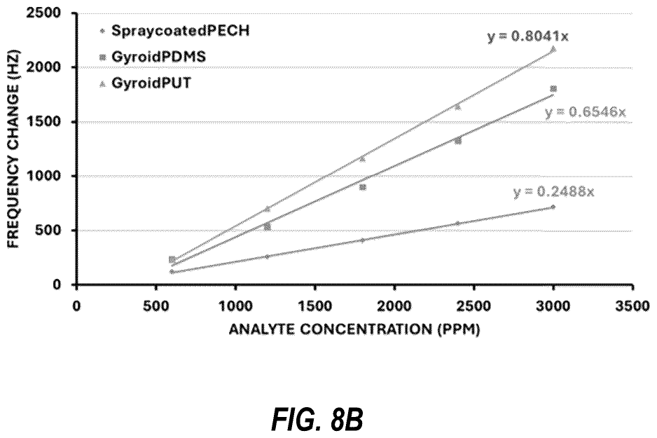

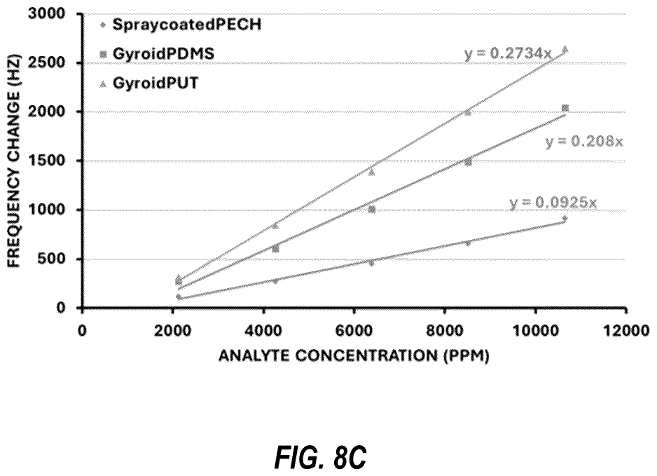

Referring to FIG. 8A, a graph showing measured relative frequency change as a function of analyte concentration for ethylbenzene is shown. The graph can plot frequency change in Hertz on a vertical axis against analyte concentration in parts per million on a horizontal axis. Three data series can be presented, corresponding to different polymer coating methods: spray-coated PECH, gyroid PDMS, and gyroid PUT. Each data series can include data points and a linear regression line.

With continued reference to FIG. 8A, the spray-coated PECH data series can show a linear relationship with a slope of approximately 0.0363 Hz/PPM, indicating a sensitivity rate for the spray-coating method. The gyroid PDMS data series can demonstrate a steeper linear relationship with a slope of approximately 0.0721 Hz/PPM, representing enhanced sensitivity compared to the spray-coated approach. The gyroid PUT data series can exhibit a slope of approximately 0.0627 Hz/PPM, also showing improved sensitivity relative to the spray-coated PECH. The concentration range tested can extend from approximately 5,000 PPM to approximately 35,000 PPM, with corresponding frequency changes ranging from near zero to over 2,000 Hz for the gyroid coatings.

Referring to FIG. 8B, a graph showing measured relative frequency change as a function of analyte concentration for M-xylene is shown. The graph can plot frequency change in Hertz on a vertical axis against analyte concentration in parts per million on a horizontal axis. Three data series can be presented, each representing a different polymer coating method on the resonant microsensor.

As further shown in FIG. 8B, a first data series can correspond to a spray-coated PECH polymer and can display a linear regression with a slope of 0.2488 Hz/PPM. A second data series can correspond to a gyroid PDMS 3D-printed polymer and can display a linear regression with a slope of 0.6546 Hz/PPM. A third data series can correspond to a gyroid PUT 3D-printed polymer and can display a linear regression with a slope of 0.8041 Hz/PPM. The sensor can achieve a sensitivity of 0.8041 Hz/PPM for M-xylene when utilizing the gyroid PUT 3D-printed polymer coating. The concentration range tested can extend from approximately 500 PPM to 3000 PPM, with the frequency change ranging from approximately 0 Hz to 2500 Hz. The graph can demonstrate that the 3D-printed gyroid structures exhibit higher sensitivity to M-xylene compared to the spray-coated polymer, with the gyroid PUT showing the highest sensitivity among the three coating methods tested.

Referring to FIG. 8C, a graph showing measured relative frequency change as a function of analyte concentration for toluene is shown. The x-axis can represent analyte concentration in parts per million (PPM), ranging from 0 to 12000 PPM. The y-axis can represent frequency change in Hertz (Hz), ranging from 0 to 3000 Hz.

With continued reference to FIG. 8C, three data series can be plotted on the graph. A first data series represented by diamond markers can correspond to spray-coated PECH, showing a linear relationship with a slope of y=0.0925x. A second data series represented by square markers can correspond to Gyroid PDMS, displaying a linear relationship with a slope of y=0.208x. A third data series represented by triangle markers can correspond to Gyroid PUT, exhibiting a linear relationship with a slope of y=0.2734x. The graph can demonstrate that the Gyroid PUT configuration achieves the highest sensitivity to toluene, followed by the Gyroid PDMS configuration, while the spray-coated PECH configuration shows the lowest sensitivity across the tested concentration range.

The sensitivity data presented in FIGS. 8A, 8B, and 8C can demonstrate that the 3D-printed gyroid structures can achieve approximately 2.5 times higher frequency change upon analyte adsorption compared to the spray-coated resonant microsensor across the three volatile organic compounds tested. The sensitivities shown by the slopes of the plots in FIGS. 8A, 8B, and 8C can show a greater difference between analytes for the 3D-printed sensitive films compared to the spray-coated film. The greater difference in sensitivity between analytes can provide an opportunity to obtain better discrimination between analytes using the 3D-printed gyroid technique compared to spray-coated polymer films.

The sensor can achieve a minimum limit of detection (LOD) of 64.2 ppb for M-xylene when utilizing the gyroid PDMS 3D-printed polymer coating. The sensor can have a short-term frequency stability of approximately 5.2 mHz with an average central frequency of 375,800 Hz for the gyroid 3D-printed device. The improvement in LOD can be attributed to the enhanced sensitivity achieved using gyroid 3D prints on the device. The 3D printed films can enhance sensitivity by approximately 2.5 times and can improve the LOD by approximately 5 times compared to sensors utilizing spray-coated polymers.

In some cases, a method of detecting an analyte can comprise providing a sensing system comprising a sensor having a polymeric 3D printed coating disposed on a surface thereof, wherein a scaffold structure of the polymeric 3D printed coating comprises a triply periodic minimal surface geometry. In some cases, the triply periodic minimal surface geometry can comprise a gyroid lattice. The gyroid lattice can provide the high surface area to volume ratio that enables the enhanced sensitivity and improved limit of detection demonstrated in FIGS. 8A, 8B, and 8C. The gyroid PUT custom-synthesized sensing film can exhibit marginally enhanced sensitivity compared to the gyroid PDMS sensing film, which can be attributable to a reduced acrylate content in the polyurethane-based resin compared to the elastomeric photoresin.

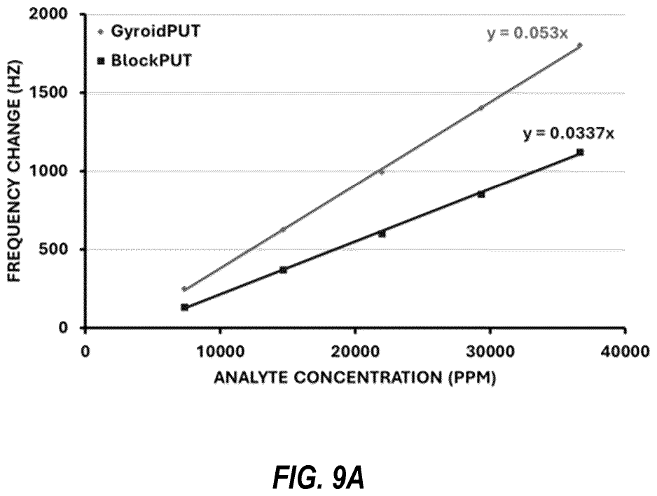

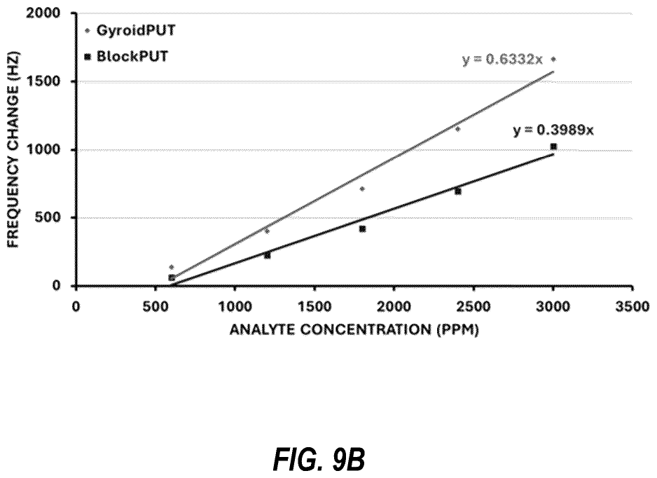

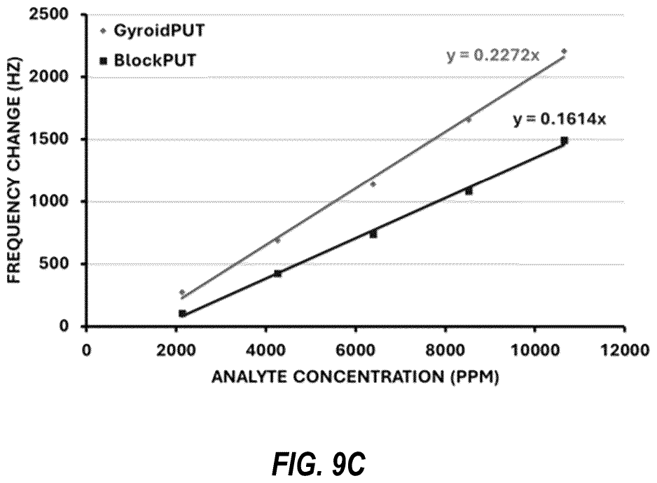

Referring to FIG. 9A, a graph showing measured relative frequency change as a function of analyte concentration for ethylbenzene is shown, comparing two different sensor configurations with different sensing film geometries. The x-axis can represent analyte concentration in parts per million (PPM), ranging from 0 to 40000 PPM. The y-axis can represent frequency change in Hertz (Hz), ranging from 0 to 2000 Hz.

With continued reference to FIG. 9A, two data series can be plotted on the graph. A first data series, labeled GyroidPUT and represented by diamond markers, can show frequency change measurements for a sensor with a gyroid-structured polyurethane 3D printed coating. A second data series, labeled BlockPUT and represented by square markers, can show frequency change measurements for a sensor with a block-structured polyurethane 3D printed coating. Linear regression trend lines can be fitted to each data series. The GyroidPUT data series can exhibit a linear relationship with a slope of y=0.053x, indicating a sensitivity of 0.053 Hz per PPM. The BlockPUT data series can exhibit a linear relationship with a slope of y=0.0337x, indicating a sensitivity of 0.0337 Hz per PPM.

As further shown in FIG. 9A, the graph can demonstrate that the gyroid-structured polymer coating achieves a higher sensitivity compared to the block-structured polymer coating, as evidenced by the steeper slope of the GyroidPUT trend line. At the highest tested concentration of approximately 35000 PPM, the GyroidPUT sensor can show a frequency change of approximately 1800 Hz, while the BlockPUT sensor can show a frequency change of approximately 1100 Hz.

Referring to FIG. 9B, a graph showing measured relative frequency change as a function of analyte concentration for M-xylene is shown, comparing the gyroid-structured and block-structured polyurethane sensing film geometries. The x-axis can represent analyte concentration in parts per million (PPM), ranging from 0 to 3500 PPM. The y-axis can represent frequency change in Hertz (Hz), ranging from 0 to 2000 Hz.

With continued reference to FIG. 9B, two data series can be plotted on the graph. A first data series, represented by diamond-shaped markers and labeled as GyroidPUT, can show frequency change measurements for the gyroid-structured polyurethane sensing film. A second data series, represented by square markers and labeled as BlockPUT, can show frequency change measurements for the block-structured polyurethane sensing film. Linear regression trend lines can be fitted to each data series. The GyroidPUT data series can have a linear regression equation of y equals 0.6332x, indicating a sensitivity of approximately 0.6332 Hz per PPM. The BlockPUT data series can have a linear regression equation of y equals 0.3989x, indicating a sensitivity of approximately 0.3989 Hz per PPM.

As further shown in FIG. 9B, the graph can demonstrate that the gyroid-structured sensing film exhibits a higher sensitivity compared to the block-structured sensing film across the tested concentration range, with the GyroidPUT showing approximately 1.6 times greater frequency response per unit concentration than the BlockPUT configuration for M-xylene.

Referring to FIG. 9C, a graph showing measured relative frequency change as a function of analyte concentration for toluene is shown, comparing the gyroid-structured and block-structured polyurethane sensing film geometries. The x-axis can represent analyte concentration in parts per million (PPM), ranging from 0 to 12000 PPM. The y-axis can represent frequency change in Hertz (Hz), ranging from 0 to 2500 Hz.

With continued reference to FIG. 9C, two data series can be plotted on the graph. A first data series, labeled GyroidPUT and represented by diamond markers, can show frequency change measurements for the gyroid-structured polyurethane sensing film. A second data series, labeled BlockPUT and represented by square markers, can show frequency change measurements for the block-structured polyurethane sensing film. Linear regression trend lines can be fitted to each data series. The GyroidPUT data series can have a linear regression equation of y=0.2272x, indicating a sensitivity of 0.2272 Hz/PPM. The BlockPUT data series can have a linear regression equation of y=0.1614x, indicating a sensitivity of 0.1614 Hz/PPM.

As further shown in FIG. 9C, the graph can demonstrate that the gyroid-structured sensing film exhibits a higher sensitivity compared to the block-structured sensing film, as evidenced by the steeper slope of the GyroidPUT trend line. Both data series can show a generally linear relationship between analyte concentration and frequency change across the tested concentration range for toluene.

The data presented in FIGS. 9A, 9B, and 9C can demonstrate that the 3D-printed gyroid PUT sensing films achieve approximately 2 times higher frequency change upon analyte adsorption compared to the 3D-printed block PUT sensing films on the resonant microsensor. The gyroid structure and the block structure can have an equivalent volume of the same polymer, which can allow for direct comparison of the effect of geometry on sensing performance. The enhanced sensitivity of the gyroid structure can be attributed to the high surface area to volume ratio provided by the triply periodic minimal surface geometry. The gyroid structure can create multiple diffusion pathways that allow analyte molecules to access the sensing material from multiple directions simultaneously, whereas the block structure can limit analyte diffusion to surfaces exposed at the exterior of the polymer volume.

The comparison between gyroid and block geometries can demonstrate that the three-dimensional scaffold structure of the polymeric 3D printed coating can enhance sensitivity beyond what is achievable through increased polymer volume alone. A block structure with equivalent polymer volume can have a lower surface area to volume ratio because the block geometry can expose only exterior surfaces for analyte interaction. The gyroid geometry can create an interconnected network of channels and voids throughout the polymer volume, which can increase the total surface area available for analyte absorption while maintaining structural integrity of the sensing film.

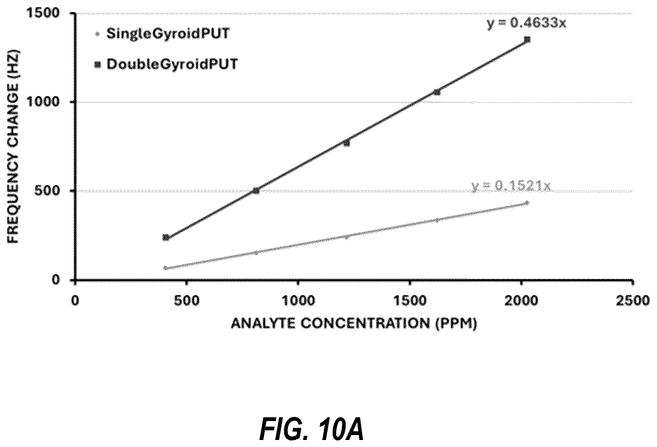

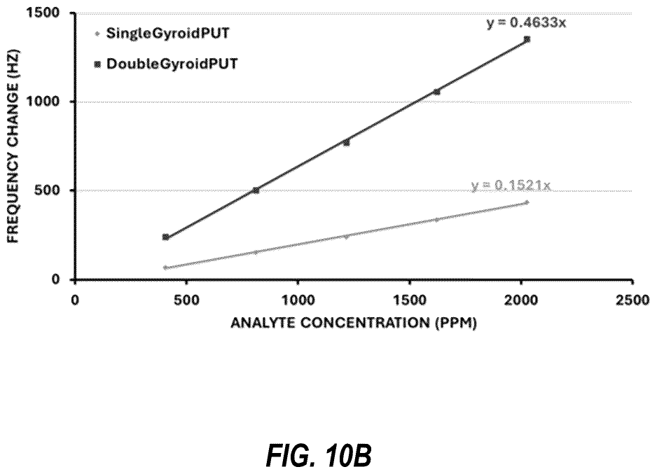

Referring to FIG. 10A, a graph showing measured relative frequency change as a function of analyte concentration for M-xylene is shown, comparing two sensors with different sensing film configurations. The x-axis can represent analyte concentration in parts per million (PPM), ranging from 0 to 2500 PPM. The y-axis can represent frequency change in Hertz (Hz), ranging from 0 to 1500 Hz.

With continued reference to FIG. 10A, two data series can be plotted on the graph. A first data series, labeled as SingleGyroidPUT, can be represented by diamond markers and can show a linear relationship with a slope defined by the equation y=0.1521x. A second data series, labeled as DoubleGyroidPUT, can be represented by square markers and can show a steeper linear relationship with a slope defined by the equation y=0.4633x. The SingleGyroidPUT configuration can correspond to a sensor having the polymeric 3D printed coating disposed on a top surface of the semicircular annulus. The DoubleGyroidPUT configuration can correspond to a sensor having the polymeric 3D printed coating disposed on both a top surface and a bottom surface of the semicircular annulus.

As further shown in FIG. 10A, the DoubleGyroidPUT configuration can demonstrate approximately three times greater sensitivity compared to the SingleGyroidPUT configuration across the tested concentration range for M-xylene. Both data series can exhibit linear responses to increasing analyte concentration, with the DoubleGyroidPUT achieving a frequency change of approximately 1350 Hz at 2000 PPM while the SingleGyroidPUT can reach approximately 450 Hz at the same concentration. The approximately three-fold increase in sensitivity can be attributed to the additional sensing surface area provided by the polymeric 3D printed coating disposed on the bottom surface of the semicircular annulus.

Referring to FIG. 10B, a graph showing measured relative frequency change as a function of analyte concentration for toluene is shown, comparing the single-sided and double-sided gyroid PUT configurations. The horizontal axis can represent analyte concentration in parts per million (PPM), ranging from 0 to 2500 PPM. The vertical axis can represent frequency change in Hertz (Hz), ranging from 0 to 1500 Hz.

With continued reference to FIG. 10B, two data series can be plotted on the graph. A first data series, labeled as SingleGyroidPUT and represented by diamond markers with a corresponding trend line, can show a linear relationship with a slope of y=0.1521x. A second data series, labeled as DoubleGyroidPUT and represented by square markers with a corresponding trend line, can demonstrate a steeper linear relationship with a slope of y=0.4633x. The DoubleGyroidPUT configuration can exhibit approximately three times greater sensitivity compared to the SingleGyroidPUT configuration across the tested concentration range for toluene, as indicated by the difference in slopes between the two trend lines.

As further shown in FIG. 10B, both data series can show linear responses to increasing analyte concentration, with the DoubleGyroidPUT reaching approximately 1350 Hz at 2000 PPM while the SingleGyroidPUT can reach approximately 450 Hz at the same concentration. The consistent approximately three-fold sensitivity enhancement observed for both M-xylene in FIG. 10A and toluene in FIG. 10B can demonstrate that the double-sided coating configuration provides a reproducible improvement in sensing performance across different volatile organic compound analytes.

The double-sided coating configuration can be achieved by printing the polymeric 3D printed coating on a first surface of the semicircular annulus, inverting the resonator, mounting the resonator to a chip holder, and printing the polymeric 3D printed coating on a second surface of the semicircular annulus opposite the first surface. The two-photon polymerization process can enable printing on the backside of the device, which is a capability not achievable through conventional spray coating methods due to limitations in directing spray-coated material to underside surfaces of suspended structures.

The double-sided coating configuration can enhance stability by providing uniform polymer mass distribution on both sides of the resonator. The uniform mass distribution can increase a quality factor of the resonator by balancing mass loading effects across the suspended structure. The polymeric 3D printed coating on both surfaces can remain confined to unstrained areas of the resonator, which can maintain high-Q operation and frequency stability despite the increased polymer mass on the device. The double-sided configuration can amplify sensitivity while minimizing total polymer volume compared to increasing thickness of a single-sided coating, which can enhance a limit of detection for volatile organic compound sensing applications.

In some cases, a sensing system can comprise multiple sensors disposed on a single sensor die. The sensor die can comprise eight sensors, though other numbers of sensors can be included on a single die. Each sensor on the sensor die can be coated with a different sensing film to enable selectivity between different analytes. The different sensing films can comprise different polymer compositions that exhibit different absorption characteristics for different volatile organic compounds.

In some cases, different sensors on the same die can be coated with different polymers to enable selectivity between different analytes. The selectivity can be achieved by selecting polymers that exhibit preferential absorption of specific analyte molecules based on chemical interactions between the polymer and the analyte. When the sensing system is exposed to an environment containing multiple volatile organic compounds, each sensor coated with a different polymer can exhibit a different frequency response pattern based on the relative absorption of each analyte by the respective polymer coating. The combination of frequency responses from multiple sensors coated with different polymers can enable identification and discrimination of different analytes in a mixture.

In some cases, the polymeric 3D printed coating can comprise polysiloxanes. The polysiloxanes can include polydimethylsiloxane (PDMS), polyoctylmethylsiloxane (POMS), poly(1,4-butadiene) methylsiloxane (P14Ms), polycyanopropylmethylsiloxane (PCPMS), or polytrifluoropropylmethylsiloxane (PTFPMS). Each polysiloxane can exhibit different absorption characteristics for different volatile organic compounds based on the chemical structure of the side groups attached to the siloxane backbone. The PDMS can provide absorption of nonpolar volatile organic compounds. The POMS can provide enhanced absorption of aromatic compounds due to the octyl side groups. The PCPMS can provide absorption of polar compounds due to the cyano functional groups. The PTFPMS can provide absorption of halogenated compounds due to the fluorinated side groups.

In some cases, the polymeric 3D printed coating can comprise polyisobutene (PIB). The PIB can be a hydrocarbon polymer that exhibits absorption of nonpolar volatile organic compounds including aliphatic and aromatic hydrocarbons. The PIB can provide a different absorption profile compared to the polysiloxanes, which can enable discrimination between analytes when PIB-coated sensors are used in combination with polysiloxane-coated sensors on the same sensor die.

In some cases, the polymeric 3D printed coating can comprise polyepichlorohydrin (PECH). The PECH can be a polyether polymer with chloromethyl side groups that exhibits absorption of polar and moderately polar volatile organic compounds. The PECH can provide absorption characteristics that differ from both the polysiloxanes and the PIB, which can further enhance selectivity when PECH-coated sensors are included in a multi-sensor array configuration.

The multi-sensor array configuration can enable pattern recognition approaches for analyte identification. Each volatile organic compound can produce a characteristic pattern of frequency responses across the array of sensors coated with different polymers. The characteristic pattern can serve as a fingerprint for the analyte that can be compared against reference patterns to identify the analyte. The use of multiple sensors with different polymer coatings can provide redundancy and can improve confidence in analyte identification compared to single-sensor configurations.

In some cases, the polymeric 3D printed coating can comprise pillar structures rather than the gyroid lattice structure. The pillar structures can comprise an array of elongated vertical elements extending from a surface of the sensor. The pillar structures can be arranged with a specific pitch between adjacent pillars. The pitch can be selected to enable capillary action between the pillar structures, which can facilitate wicking of fluids to the sensor surface.

In some cases, the sensing system can be configured for liquid-phase sensing applications. The liquid-phase sensing configuration can utilize the pillar structures to wick fluid samples to the resonator surface rather than immersing the device in the fluid. The wicking action can draw a thin film of liquid sample across the sensor surface through capillary forces generated between adjacent pillar structures. The capillary forces can arise from surface tension interactions between the liquid sample and the pillar surfaces.

The pillar structures can be fabricated using the two-photon polymerization process. The two-photon polymerization process can enable precise control over pillar dimensions including height, diameter, and pitch. The pitch between adjacent pillars can be selected based on properties of the fluid to be sensed, including surface tension and viscosity. A smaller pitch can generate stronger capillary forces for fluids with higher surface tension, while a larger pitch can accommodate fluids with lower surface tension or higher viscosity.

The liquid-phase sensing configuration can enable detection of analytes dissolved in liquid samples without requiring full immersion of the resonator in the liquid. Full immersion of the resonator in liquid can dampen oscillation of the resonator due to viscous drag from the surrounding liquid, which can reduce quality factor and frequency stability. The wicking configuration can maintain a thin liquid film on the sensor surface while leaving portions of the resonator exposed to air or a gaseous environment, which can preserve oscillation characteristics of the resonator.

In some cases, the pillar structures can be disposed on the head region of the cantilever-based resonator while the cantilever portion remains free of the pillar structures. The confinement of the pillar structures to the head region can maintain mechanical properties of the resonator by avoiding deposition of additional mass on the cantilever portion where deflection occurs. The pillar structures can provide a defined region for liquid sample interaction while isolating the liquid sample from regions of the resonator where liquid contact could interfere with oscillation.

The pillar structures can be combined with the gyroid lattice structure in some configurations. A hybrid structure can comprise pillar structures disposed at a periphery of the sensing region to wick fluid samples toward a central region comprising the gyroid lattice structure. The gyroid lattice structure can provide high surface area for analyte absorption once the fluid sample has been wicked to the sensing region by the pillar structures.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A sensing system, comprising:
a sensor comprising a resonator structure; and
a polymeric 3D printed coating disposed on a surface of at least a portion of the sensor, wherein the polymeric 3D printed coating comprises a three-dimensional scaffold structure.

2. The sensing system of claim 1, wherein the resonator structure comprises a semicircular annulus and a cantilever, and wherein the polymeric 3D printed coating is disposed on at least a portion of an outer surface of the semicircular annulus.

3. The sensing system of claim 2, wherein the polymeric 3D printed coating is disposed on at least a portion of a top surface of the semicircular annulus.

4. The sensing system of claim 3, wherein the polymeric 3D printed coating is disposed on at least a portion of a bottom surface of the semicircular annulus.

5. The sensing system of claim 1, wherein the three-dimensional scaffold structure comprises a triply periodic minimal surface geometry.

6. The sensing system of claim 5, wherein the triply periodic minimal surface geometry comprises a gyroid lattice.

7. The sensing system of claim 1, wherein the polymeric 3D printed coating comprises an elastomeric photoresin.

8. The sensing system of claim 7, wherein the elastomeric photoresin comprises at least 90 wt. % of (acryloxypropyl)methylsiloxane-dimethylsiloxane copolymer.

9. The sensing system of claim 1, wherein the polymeric 3D printed coating comprises a polyurethane-based resin.

10. A chemical sensor device, comprising:
a cantilever-based resonator having a head region and a cantilever portion; and
a polymer sensing film disposed on at least a portion of the head region, wherein the polymer sensing film comprises a 3D printed structure formed by two-photon polymerization.

11. The chemical sensor device of claim 10, wherein the head region comprises a semicircular annulus.

12. The chemical sensor device of claim 11, wherein the cantilever-based resonator comprises a hammerhead configuration in which the semicircular annulus is supported by the cantilever portion.

13. The chemical sensor device of claim 10, wherein the 3D printed structure comprises a triply periodic minimal surface geometry.

14. The chemical sensor device of claim 13, wherein the triply periodic minimal surface geometry comprises a gyroid lattice.

15. The chemical sensor device of claim 10, wherein the polymer sensing film is disposed on both a top surface and a bottom surface of the head region.

16. The chemical sensor device of claim 10, wherein the polymer sensing film comprises a solvent-free photoresin.

17. A method of detecting an analyte, comprising:
providing a sensing system comprising a sensor having a polymeric 3D printed coating disposed on a surface thereof;
exposing the sensing system to an environment containing one or more analytes; and
measuring a frequency change of the sensor in response to absorption of the one or more analytes by the polymeric 3D printed coating.

18. The method of claim 17, wherein the scaffold structure comprises a triply periodic minimal surface geometry.

19. The method of claim 18, wherein the triply periodic minimal surface geometry comprises a gyroid lattice.

20. The method of claim 17, wherein the one or more analytes comprise volatile organic compounds.
